(19) United States
(12) Patent Application Publication
(10) Pub. No.: US 2020/0282543 A1
(43) Pub. Date: Sep. 10, 2020

(54) Socket Drive Assembly

(71) Applicant: Ronald Grzybowski, Water Mill, NY (US)

(72) Inventor: Ronald Grzybowski, Water Mill, NY (US)

(21) Appl. No.: 16/296,716

(22) Filed: Mar. 8, 2019

(51) Int. Cl. B25G 1/00; B25B 23/00; B25G 3/26

(52) U.S. Cl. CPC B25G 1/007; B25G 3/26; B25B 23/0042; B25B 23/0021

(57) ABSTRACT

A socket drive assembly for rotating a fastener with 360.0 degrees of rotation includes a wrench that has a first end and a second end. A socket drive is coupled to the wrench and the socket drive extends along an axis that is oriented perpendicular to the longitudinal axis of the wrench. The socket drive includes a ⅜ inch drive and a ¼ inch drive for engaging either a ⅜ socket or a ¼ socket. A handle is removably coupled to the wrench and the handle is oriented to rotate about an axis is oriented perpendicular to the longitudinal axis of the wrench. In this way the handle facilitates the wrench to be rotated 360.0 degrees around a fastener that is loosened or tightened.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to drive devices and more particularly pertains to a new drive device for rotating a fastener with 360.0 degrees of rotation.

### BRIEF SUMMARY OF THE INVENTION

An embodiment of the disclosure meets the needs presented above by generally comprising a wrench that has a first end and a second end. A socket drive is coupled to the wrench and the socket drive extends along an axis that is oriented perpendicular to the longitudinal axis of the wrench. The socket drive includes a ⅜ inch drive and a ¼ inch drive for engaging either a ⅜ socket or a ¼ socket. A handle is removably coupled to the wrench and the handle is oriented to rotate about an axis is oriented perpendicular to the longitudinal axis of the wrench. In this way the handle facilitates the wrench to be rotated 360.0 degrees around a fastener that is loosened or tightened.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a socket drive assembly according to an embodiment of the disclosure.

FIG. 2 is a right side view of an embodiment of the disclosure.

FIG. 3 is a bottom view of an embodiment of the disclosure.

FIG. 4 is a top view of an embodiment of the disclosure.

FIG. 5 is a cross sectional view taken along line 5-5 of FIG. 4 of an embodiment of the disclosure.

FIG. 6 is a perspective in-use view of an embodiment of the disclosure.

FIG. 7 is a top perspective view on an alternative embodiment of the disclosure.

FIG. 8 is a perspective view of an alternative embodiment of the disclosure.

### DETAILED DESCRIPTION OF THE INVENTION

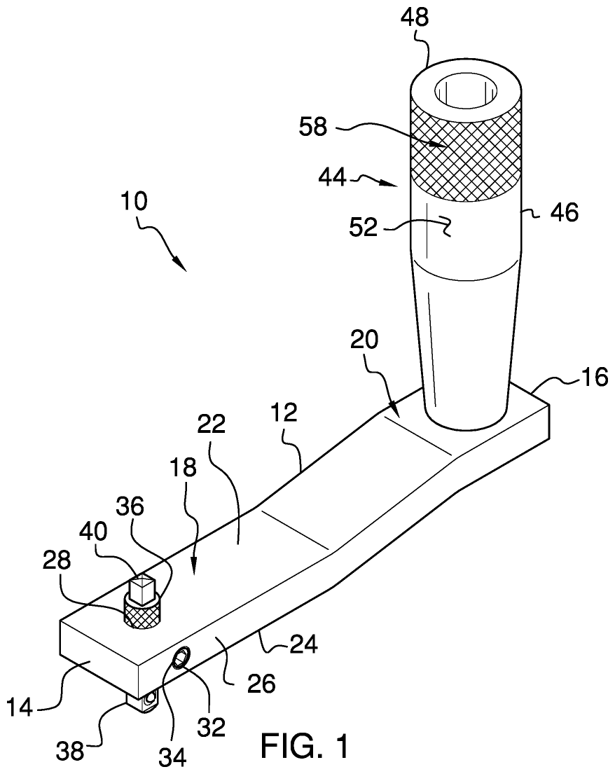

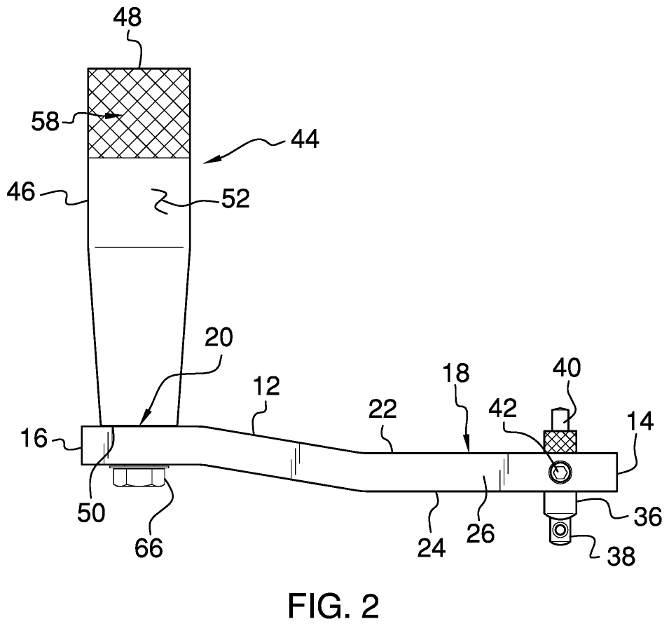

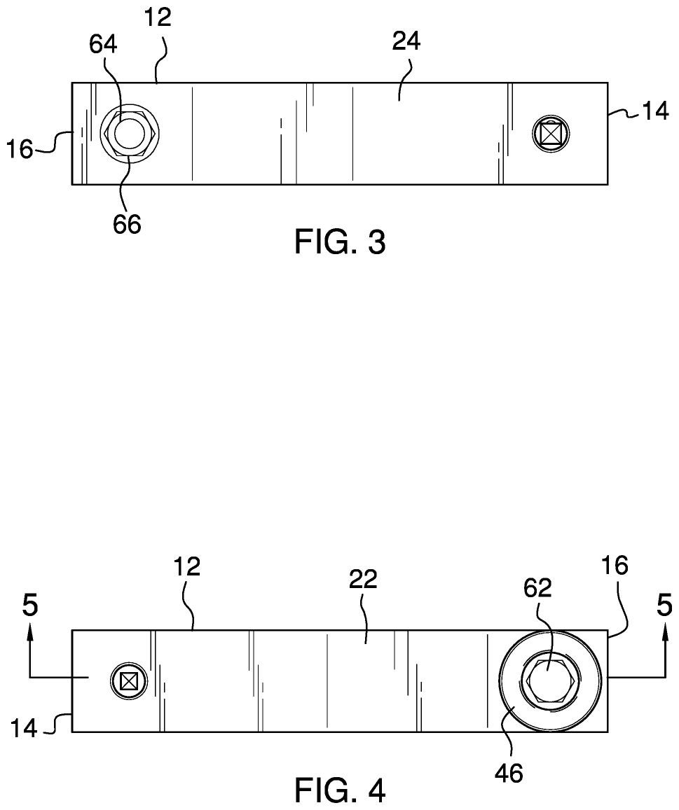

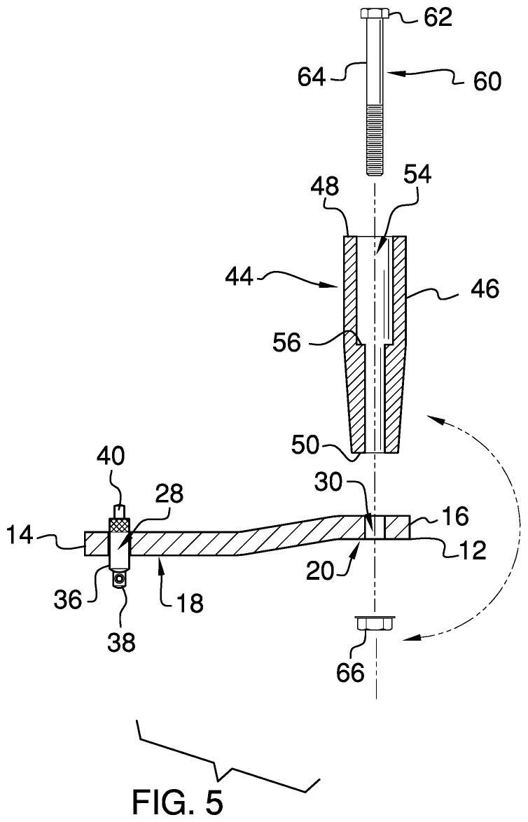

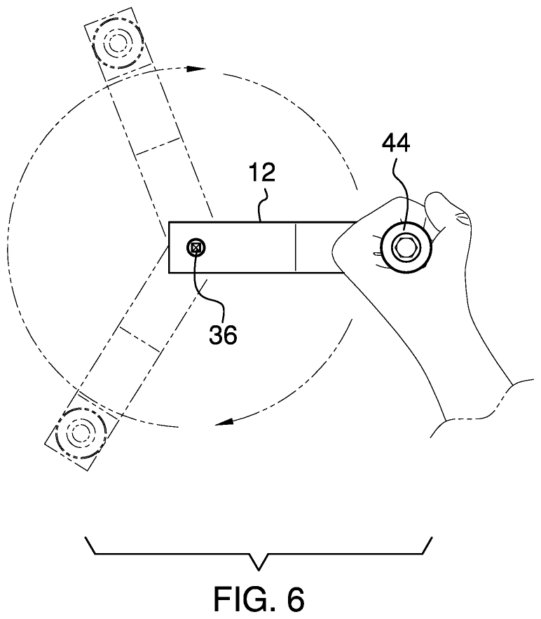

With reference now to the drawings, and in particular to FIGS. 1 through 8 thereof, a new drive device embodying the principles and concepts of an embodiment of the disclosure and generally designated by the reference numeral 10 will be described.

As best illustrated in FIGS. 1 through 8, the socket drive assembly 10 generally comprises a wrench 12 has a first end 14 and a second end 16 and the wrench 12 is elongated between the first 14 and second 16 ends. Additionally, the wrench 12 undulates between the first 14 and second 16 ends such that the first end 14 is offset from the second end 16 with respect to a longitudinal axis of the wrench 12. The wrench 12 has a first portion 18 extending from the first end 14 toward the second end 16 and the wrench 12 has a second portion 20 extending from the second end 16 toward the first end 14. The first portion 18 has a length of approximately 2.5 inches and the second portion 20 has a length of approximately 1.125 inches.

The wrench 12 has a top side 22, a bottom side 24 and a first lateral side 26. The first portion 18 has a first aperture 28 extending through the top 22 and bottom 24 sides, and the first aperture 28 is spaced from the first end 14. The second portion 20 has a second aperture 30 extending through the top 22 and bottom 24 sides, and the second aperture 30 is spaced from the second end 16. The first lateral side 26 has a well 32 extending therein and intersects the first aperture 28. Moreover, the well 32 has a bounding surface 34 and the bounding surface 34 is threaded.

A socket drive 36 is coupled to the wrench 12 and the socket drive 36 extends along an axis that is oriented perpendicular to the longitudinal axis of the wrench 12. The socket drive 36 includes a ⅜ inch drive 38 and a ¼ inch drive 40 for engaging either a ⅜ socket or a ¼ socket. The socket drive 36 extends through the first aperture 28 having the ⅜ inch drive 38 being spaced from the bottom side 24 of the wrench 12 and having the ¼ inch drive 40 being spaced from the top side 22 of the wrench 12. A set screw 42 threadably engages the bounding surface 34 of the well 32 in the first lateral side 26 of the wrench 12. The set screw 42 is tightened against the socket drive 36 for retaining the socket drive 36 in the first aperture 28.

A handle 44 is removably coupled to the wrench 12 and the handle 44 is oriented to rotate about an axis that is oriented perpendicular to the longitudinal axis of the wrench 12. In this way the handle 44 facilitates the wrench 12 to be rotated 360.0 degrees around a fastener that is loosened or tightened. The handle 44 comprises a cylinder 46 that has a top end 48, a bottom end 50 and an outer surface 52 extending therebetween.

The cylinder 46 has an aperture 54 extending through the top 48 and bottom 50 ends. The aperture 54 in the cylinder 46 has a shoulder 56 therein and the shoulder 56 is centrally positioned between the top 48 and bottom 50 ends. Additionally, the bottom end 50 of the cylinder 46 is positionable on either the top side 22 of the wrench 12 or the bottom side 24 of the wrench 12 having the aperture 54 in the cylinder 46 being aligned with the second aperture 30 in the wrench 12. In this way either the ⅜ inch drive 38 or the ¼ in drive can be inserted into a socket for turning a fastener. Moreover, the outer surface 52 of the cylinder 46 has a knurled portion 58 for enhancing gripping the cylinder 46.

The handle 44 includes a bolt 60 that has a head 62 and a shaft 64. The bolt 60 is extended downwardly through the aperture 54 in the cylinder 46 having the head 62 abutting the shoulder 56 and having the shaft 64 extending through the second aperture 30 in the wrench 12. A nut 66 is provided for threadably engaging the shaft 64 of the bolt 60 and rotatably retaining the cylinder 46 on the wrench 12. The outer surface 52 of the cylinder 46 is gripped for turning the wrench 12 thereby facilitating the cylinder 46 to rotate about an axis that is oriented perpendicular to the longitudinal axis of the wrench 12. In this way the handle 44 can rotate about an axis that is oriented parallel to a rotational axis of a fastener is loosened or tightened with the wrench 12.

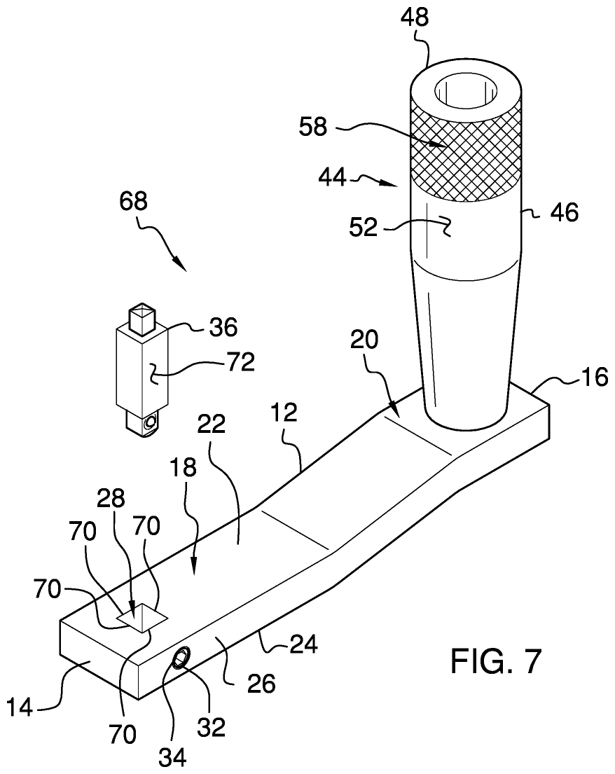

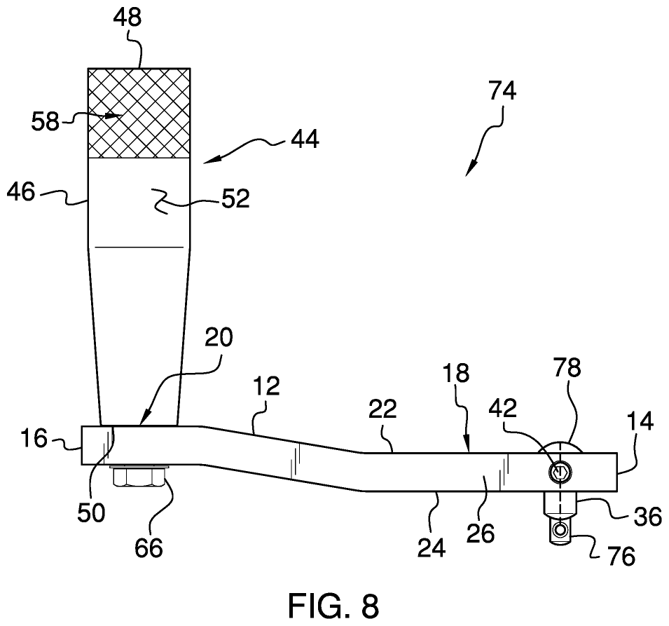

In an alternative embodiment 68 as is most clearly shown in FIG. 7, the first aperture 28 may have a plurality of intersecting sides 70 such that the first aperture 28 has a rectangular shape. Additionally, the socket drive 36 may have a rectangular outer surface 72 to conform to the intersecting sides 70 of the first aperture 28. In this way the socket drive 36 is inhibited from rotating in the first aperture 28 when the fastener is rotated. In an alternative embodiment 74 as is most clearly shown in FIG. 8, the socket drive 36 may comprise a ¼ inch or ⅜ inch drive 76 extending downwardly from the bottom side 24 of the wrench 12. A direction switch 78 may be movably positioned on the top side 22 of the wrench 12 to adjust the direction of rotation for the ¼ inch or ⅜ inch drive 76.

In use, the handle 44 is positioned on either of the top 22 or bottom 24 sides of the wrench 12 to facilitate either of the ⅜ inch drive 38 or the ¼ inch drive 40 to be inserted into a socket having the handle 44 extending upwardly from the wrench 12. The handle 44 is gripped and the wrench 12 is rotated about the rotational axis of the fastener being loosened or tightened. Additionally, the wrench 12 can be rotated a full 360.0 degrees about the fastener. The handle 44 rotates about an axis that is parallel to the rotational axis of the fastener thereby enhancing ergonomic comfort for a user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A socket drive assembly having a grip being rotatable about an axis being perpendicular to a rotational axis of a fastener, said assembly comprising:
a wrench having a first end and a second end, said wrench being elongated between said first and second ends, said wrench undulating between said first and second ends such that said first end is offset from said second end with respect to a longitudinal axis of said wrench;
a socket drive being coupled to said wrench, said socket drive extending along an axis being oriented perpendicular to said longitudinal axis of said wrench, said socket drive including a ⅜ inch drive and a ¼ inch drive wherein said socket drive is configured to engage either a ⅜ socket or a ¼ socket; and
a handle being removably coupled to said wrench, said handle being oriented to rotate about an axis being oriented perpendicular to said longitudinal axis of said wrench wherein said handle is configured to facilitate said wrench to be rotated 360.0 degrees around a fastener being loosened or tightened.

2. The assembly according to claim 1, wherein:
said wrench has a first portion extending from said first end toward said second end, said first portion having a length of approximately 2.5 inches;
said wrench has a second portion extending from said second end toward said first end, said second portion having a length of approximately 1.125 inches;
said wrench has a top side, a bottom side and a first lateral side;
said first portion has a first aperture extending through said top and bottom sides, said first aperture being spaced from said first end;
said second portion has a second aperture extending through said top and bottom sides, said second aperture being spaced from said second end; and
said first lateral side has a well extending therein and intersecting said first aperture, said well having a bounding surface, said bounding surface being threaded.

3. The assembly according to claim 2, further comprising said socket drive extending through said first aperture having said ⅜ inch drive being spaced from said bottom side of said wrench and having said ¼ inch drive being spaced from said top side of said wrench.

4. The assembly according to claim 2, further comprising a set screw threadably engaging said bounding surface of said well in said first lateral side of said wrench, said set screw being tightened against said socket drive for retaining said socket drive in said first aperture.

5. The assembly according to claim 2, wherein:
said handle comprises a cylinder having a top end, a bottom end and an outer surface extending therebetween:
said cylinder has an aperture extending through said top and bottom ends, said aperture in said cylinder having a shoulder therein, said shoulder being centrally positioned between said top and bottom ends;
said bottom end of said cylinder being positionable on either said top surface of said wrench or said bottom surface of said wrench having said aperture in said cylinder being aligned with said second aperture in said wrench; and
said outer surface of said cylinder has a knurled portion for enhancing gripping said cylinder.

6. The assembly according to claim 5, further comprising a bolt having a head and a shaft, said bolt being extended downwardly through said aperture in said cylinder having said head abutting said shoulder and having said shaft extending through said second aperture in said wrench.

7. The assembly according to claim 6, further comprising a nut threadably engaging said shaft of said bolt for rotatably retaining said cylinder on said wrench, said outer surface of said cylinder being gripped for turning said wrench thereby facilitating said cylinder to rotate about an axis being oriented perpendicular to said longitudinal axis of said wrench wherein said handle is configured to rotate about an axis being oriented parallel to a rotational axis of a fastener being loosened or tightened with said wrench.

8. A socket drive assembly having a grip being rotatable about an axis being perpendicular to a rotational axis of a fastener, said assembly comprising:
a wrench having a first end and a second end, said wrench being elongated between said first and second ends, said wrench undulating between said first and second ends such that said first end is offset from said second end with respect to a longitudinal axis of said wrench, said wrench having a first portion extending from said first end toward said second end, said wrench having a second portion extending from said second end toward said first end, said first portion having a length of approximately 2.5 inches, said second portion having a length of approximately 1.125 inches, said wrench having a top side, a bottom side and a first lateral side, said first portion having a first aperture extending through said top and bottom sides, said first aperture being spaced from said first end, said second portion having a second aperture extending through said top and bottom sides, said second aperture being spaced from said second end, said first lateral side having a well extending therein and intersecting said first aperture, said well having a bounding surface, said bounding surface being threaded;
a socket drive being coupled to said wrench, said socket drive extending along an axis being oriented perpendicular to said longitudinal axis of said wrench, said socket drive including a ⅜ inch drive and a ¼ inch drive wherein said socket drive is configured to engage either a ⅜ socket or a ¼ socket, said socket drive extending through said first aperture having said ⅜ inch drive being spaced from said bottom side of said wrench and having said ¼ inch drive being spaced from said top side of said wrench;
a set screw threadably engaging said bounding surface of said well in said first lateral side of said wrench, said set screw being tightened against said socket drive for retaining said socket drive in said first aperture; and
a handle being removably coupled to said wrench, said handle being oriented to rotate about an axis being oriented perpendicular to said longitudinal axis of said wrench wherein said handle is configured to facilitate said wrench to be rotated 360.0 degrees around a fastener being loosened or tightened, said handle comprising:
a cylinder having a top end, a bottom end and an outer surface extending therebetween, said cylinder having an aperture extending through said top and bottom ends, said aperture in said cylinder having a shoulder therein, said shoulder being centrally positioned between said top and bottom ends, said bottom end of said cylinder being positionable on either said top surface of said wrench or said bottom surface of said wrench having said aperture in said cylinder being aligned with said second aperture in said wrench, said outer surface of said cylinder having a knurled portion for enhancing gripping said cylinder;
a bolt having a head and a shaft, said bolt being extended downwardly through said aperture in said cylinder having said head abutting said shoulder and having said shaft extending through said second aperture in said wrench; and
a nut threadably engaging said shaft of said bolt for rotatably retaining said cylinder on said wrench, said outer surface of said cylinder being gripped for turning said wrench thereby facilitating said cylinder to rotate about an axis being oriented perpendicular to said longitudinal axis of said wrench wherein said handle is configured to rotate about an axis being oriented parallel to a rotational axis of a fastener being loosened or tightened with said wrench.
